(19) United States
(12) Patent Application Publication
(10) Pub. No.: US 2005/0211863 A1
(43) Pub. Date: Sep. 29, 2005

(54) Computer workstation

(76) Inventor: Charles A. Masi, Cos Cob, CT (US)

Correspondence Address: EDWARDS & ANGELL, LLP, P.O. BOX 55874, BOSTON, MA, 02205, US

(21) Appl. No.: 11/087,019

(22) Filed: Mar. 22, 2005

Related U.S. Application Data
(60) Provisional application No. 60/555,624, filed on Mar. 23, 2004.

(51) Int. Cl. B41J 11/02

(52) U.S. Cl. 248/442.2

(57) ABSTRACT

Disclosed is are computer workstations that are ergonomically configured for use in, for example, research laboratories, commercial facilities and retail stores where the operator is routinely standing. The disclosed computer includes, inter alia, a base unit, a keyboard tray and a monitor arm. The base unit has an upper surface and at least two legs depending downward therefrom. The two legs of the base unit are adapted for supporting the workstation on a working surface which is spaced vertically from a floor. The keyboard tray is mounted to the base unit and includes a keyboard support surface and mechanism for articulating the keyboard support surface with respect to the upper surface of the base unit. The monitor arm is also mounted to the base unit and includes a monitor support surface and mechanism for articulating the monitor support surface with respect to the upper surface of the base unit.

### CROSS REFERENCE TO RELATED APPLICATIONS

This application claims priority to U.S. Provisional Patent Application No. 60/555,624 filed Mar. 23, 2004, which is herein incorporated by reference in its entirety.

### BACKGROUND OF THE INVENTION

1. Field of the Invention

The present invention relates to computer workstations, and more particularly, to computer workstations that are ergonomically configured for use in, for example, research laboratories, commercial facilities and retail stores where the operator is routinely standing.

2. Background of the Related Art

It is widely recognized that a computer operator must be properly positioned with respect to the keyboard, mouse and monitor in order to avoid creating unnecessary strain on the operator's body and eyes. In view of this, many devices have been created in an effort to improve the ergonomics of the working environment for computer users. The vast majority of these items are designed to facilitate the installation of individual components of the computer system (e.g., keyboard, mouse, monitor) on a standard desk. For example, numerous keyboard trays have been designed which are mounted to the underside of a desk's working surface and can be retracted for storage when not in use.

Prior art devices have solved many of the ergonomic challenges associated with desktop computer workstations where the operator is most often sitting in a chair. Unfortunately, many laboratories, factories and retail stores have computer workstations which are used by operators that are often, if not always, standing. As a result, the operator is forced to bend over and severely arch his/her neck in order to properly view the monitor and/or access the keyboard and mouse. Over the course of a normal workday, such awkward posture can create a significant amount of strain on the neck, shoulders and eyes and this strain could potentially result in permanent injury to the operator.

One solution to this problem has been the development of sit/stand workstations, as illustrated in U.S. Pat. No. 6,374,752 to Walser. The Wasler patent discloses a portable computer workstation, which includes a powered lifting mechanism which allows simultaneous vertical motion of a monitor and keyboard. The entire workstation, including the computer, tower is preferably mounted to a base unit that rests on swivel casters so as to allow the workstation to be readily moved from position to position.

The Walser patent solves some of the problems associated with prior art devices in that it provides an ergonomically acceptable workstation for an operator who is standing. However, the Walser workstation is not easily adapted for use in laboratory, commercial or retail environments. The Walser workstation is cumbersome, not easily repositioned in a crowded workspace and would not be aesthetically pleasing in a retail store. Moreover, in a laboratory, much of the work is performed on a bench by a person who is standing, and therefore, it would be advantageous to have a computer workstation that is adapted for installation on a work bench so that the operator does not have to continually swing around to access the computer for data input or other repetitive tasks.

Therefore, there is a need for a computer workstation which can be easily adapted for use in both bench top and desktop applications where the operator is routinely standing.

### SUMMARY OF THE INVENTION

The present invention relates to computer workstations that are ergonomically configured for use in, for example, research laboratories, commercial facilities and retail stores where the operator is routinely standing.

More specifically, the present disclosure is directed to portable workstations for computers which have a keyboard, a mouse and a video monitor. The portable workstation includes, inter alia, a base unit, a keyboard tray and a monitor arm. The base unit has an upper surface and at least two legs depending downward therefrom. The two legs of the base unit are adapted for supporting the workstation on a working surface which is spaced vertically from a floor. In a preferred embodiment, the base unit further includes means for securing the base unit to the working surface. Additionally, embodiments of the present invention can include a mechanism for adjusting the height of the upper surface of the base unit with respect to the working surface. For example, adjustable support feet can be provided with each leg of the base unit.

The keyboard tray is mounted to the base unit and includes a keyboard support surface and mechanism for articulating the keyboard support surface with respect to the upper surface of the base unit. The monitor arm is also mounted to the base unit and includes a monitor support surface and mechanism for articulating the monitor support surface with respect to the upper surface of the base unit. In a preferred embodiment of the disclosed computer workstation, the keyboard tray and monitor arm are mounted to the upper surface of the base unit.

It is presently envisioned that the keyboard support surface is adapted and configured for being articulated vertically and horizontally with respect to the upper surface of the base unit. Still further, the monitor support surface is also adapted and configured for being articulated vertically, horizontally and in a front-to-back direction with respect to the upper surface of the base unit.

In certain representative embodiments, the monitor support surface includes structure for securing a video monitor thereto. Those skilled in the art will readily appreciate that the structure for securing the video monitor can include a variety known devices, such as for example, straps, clips, hooks, screws and etc. Moreover, in embodiments of the present invention which are intended to be used with a computer having a flat screen or LCD type monitor, the structure for securing the video monitor to the support surface is adapted for supporting a flat screen monitor in an upright position.

It is presently envisioned that the computer workstation of the present disclosure can further include a mouse tray which is supported by the keyboard tray.

Preferably, the portable computer workstation disclosed herein includes a keyboard tray that is adapted and configured for articulating between an extended position, wherein a keyboard mounted thereon can be accessed by a user, and a retracted position wherein the keyboard tray is disposed under the upper surface of the base unit, between the legs of the base unit.

The present disclosure is also directed to a portable workstation for a computer having a keyboard, a mouse and a video monitor that includes, inter alia, a base unit, a keyboard tray, a monitor arm wherein the base unit includes means for supporting the a laptop docking station. Preferably, in such an embodiment, the base unit is made from aluminum and includes a mechanism, such as screws or clams, for securing the base unit to the working surface.

### BRIEF DESCRIPTION OF THE DRAWINGS

So that those having ordinary skill in the art to which the present application appertains will more readily understand how to make and use the same, reference may be had to the drawings wherein:

FIG. 1 is a perspective view of the computer workstation in accordance with the present invention having a keyboard and mouse installed in their respective trays;

FIG. 2 is a perspective view of the computer workstation of FIG. 1 as viewed from the side with a monitor installed on the monitor stand;

FIG. 3 is a perspective view (front) of the base unit for the computer workstation of FIGS. 1 and 2 which illustrates the support feet threaded into the left and right flanges of the base unit legs;

FIG. 4 is a perspective view of the bottom of the base unit showing the prearranged pem nuts attached to the underside of the elevated mounting surface;

FIG. 5 is a side elevational view of the computer workstation of the present invention mounted on top of a desk with an operator shown in the standing position;

FIG. 6 is a side elevation of the computer workstation of the present invention in the retracted/stored position; and

FIG. 7 is perspective view taken from the side of an alternative embodiment of the workstation of the present invention that has a mounting arm adapted for use with a flat screen monitor.

These and other features of the computer workstation of the present application will become more readily apparent to those having ordinary skill in the art form the following detailed description of the preferred embodiments.

### DETAILED DESCRIPTION OF PREFERRED EMBODIMENTS

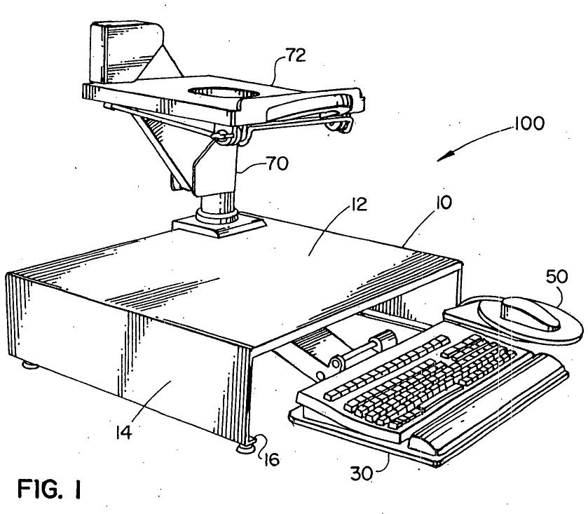

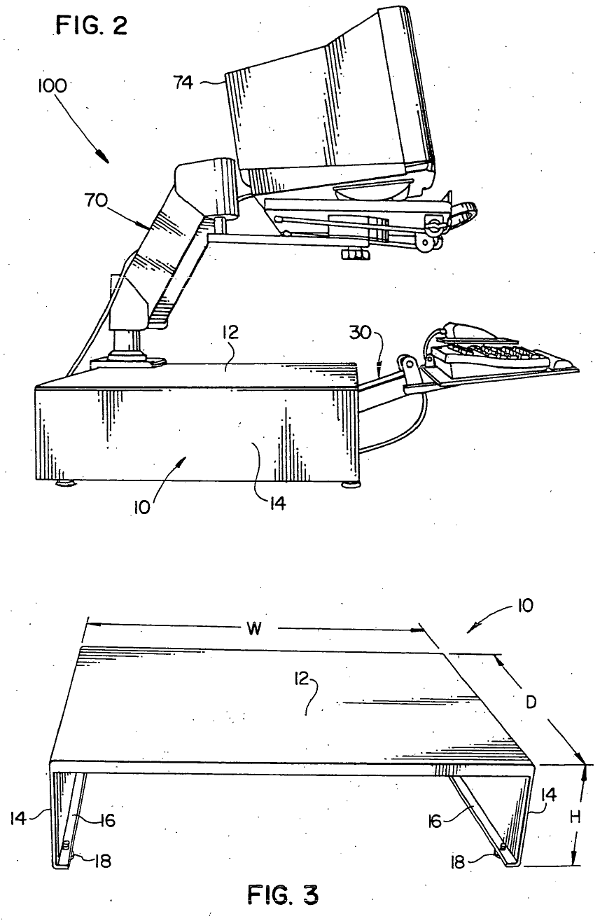

Referring now to the drawings wherein like reference numerals identify similar structural aspects of the subject invention, there is illustrated in FIGS. 1 and 2 a computer workstation which is designated by reference numeral 100. As will be described in detail herein below, computer workstation 100 provides an ergonomic solution to both bench top and desktop applications where the operator is routinely standing.

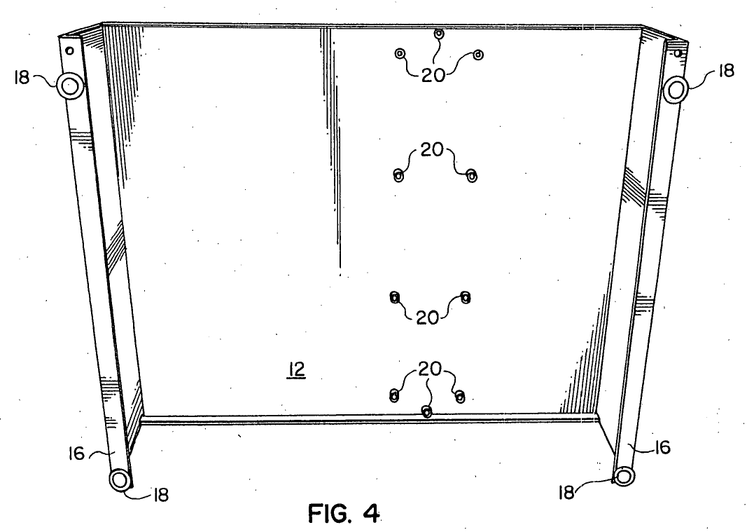

Computer workstation 100 includes, inter alia, a base unit 10, a keyboard tray 30, a mouse tray 50 and a monitor arm 70. The base unit 10 is shown in FIG. 3, without the other components of workstation 100 attached thereto. Base unit 10 preferably includes an elevated mounting surface 12 having two legs 14 depending therefrom, each leg 14 including an inwardly projecting horizontal mounting flange 16 (FIG. 3).

The height (H), width (W) and depth (D) of base unit 10 is established to suit the desired application for workstation 100 and the type of keyboard tray selected. For example, the keyboard tray can be a Versatech™ Model #FS73997 which is designed to hold a standard size keyboard and includes a mouse tray extension or a Humanscale Model #2G941RF. The Humanscale combination tray assembly is 22″ wide and includes a mounting plate that is 5-½″ wide by 22″ deep and therefore, the spacing between the legs 14 of the base unit 10 and the depth of the elevated mounting surface 12 must accommodate these features.

The inwardly projecting horizontal flanges 16 include four thread holes for receiving the threaded posts of the support feet 18. The threaded support feet 18 allow the base unit to be leveled if the desktop or bench surface is at a slight incline or if the surface is uneven. In addition, it is envisioned that in some applications it may be advantageous to securely mount the computer workstation 100 to the desk or bench top. In these applications, the support feet can be replaced with screws or a clamping device, for example.

The base unit 10 is preferably made from steel, but as will be appreciated by those skilled in the art, materials such as aluminum can be used for lightweight applications. A lightweight application may be one that requires the workstation 100 to be more readily portably or moved from one location to another. Additionally, as shown in FIG. 7, the computer workstation 100 of the present invention may be adapted for use with a flat screen monitor which is considerably lighter than a traditional tube monitor. As shown in this figure, monitor arm 170 has a vertically-oriented mounting plate 172 that is adapted for use with a flat screen monitor.

However, it should be noted that in lightweight applications, such as those described above, the weight of the base unit alone may not be sufficient to ensure that the computer workstation 100 rests stably on the bench or desk surface. In these applications it may be advantageous to replace support feet 18 with a mechanism for securing the workstation 100 to the bench or desk top.

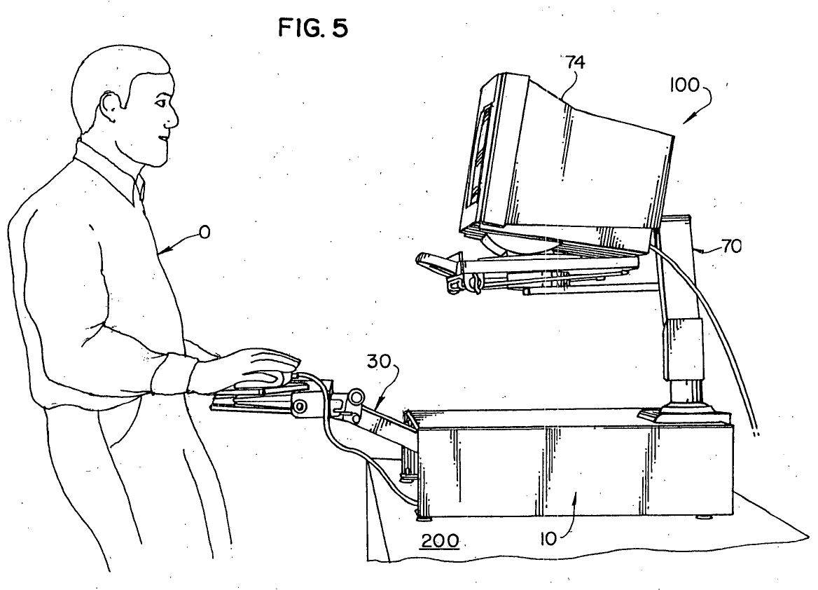

Referring again to FIGS. 1 and 2, keyboard tray 30 and mouse tray 50 are shown as a combination unit which is attached to the underside of the elevated mounting surface 12 of the base unit 10 using a single mounting plate. In alternative embodiments, the trays 30/50 can be separate units which are each attached directly to the base unit 10 without departing from the inventive aspects of the present disclosure. Preferably, during fabrication of the base unit 10, pem nuts 20 (FIG. 4) are pressed into the underside of the elevated mounting surface 12. The pem nuts 20 are arranged in a pattern to suit the holes provided in the mounting plate for the keyboard tray 30. Pem nuts are self-clinching nuts that provide permanent load-bearing threads in metal sheets too thin to be tapped and offer a practical alternative to extruded/tapped or stamped threads. The use of pem nuts 20 is advantageous in that it eliminates the need for holes in the mounting surface 12 of the base unit 10, thereby allowing the elevated mounting surface 12 to remain smooth and free of screw heads or other fastening devices.

Keyboard tray 30 is retractable and can slide between the legs 14 of the base unit 10 for storage. Still further, most commercially available key board trays include a mechanism for adjusting the height of the tray with respect to the mounting surface and a tilt feature for adjusting the angle of the typing surface.

Monitor arm 70 is also attached directly to the elevated mounting surface 12 of the base unit 10 by means of fastening or clamping. The monitor arm 70 includes a monitor support plate 72 upon which the monitor 74 (FIG. 2) rests. The monitor arm can be for example, a Versatech Model #FS74693 which is capable of supporting 20 to 70 lb monitors. Such arms include a pneumatic counterbalance system which allows fingertip adjustment of the monitor position. The monitor 74 can be adjusted from a height of 5″ to approximately 13″ above the mounting surface, in this case the elevated mounting surface 12 of the base unit 10. As shown in FIG. 7, in alternative embodiments, a monitor arm 170 which is adapted for use with flat screen monitors can also be used in computer workstation 100. Monitor arm 170 includes a monitor support surface 172 on which a flat screen monitor can be mounted.

Referring now to FIG. 5, there is illustrated computer workstation 100 resting on a table top 200 and being be used by an operator (O). As can be readily seen, by attaching the adjustable monitor arm 70 and adjustable keyboard tray 30 to the elevated mounting surface 12 of the base unit 10, the operator can set the proper ergonomic arrangement of all of the computer's components to the optimal configuration. Still further, computer workstation 100 can be readily relocated to a bench top application, such as a laboratory, and again, the orientation of the monitor 74 and the keyboard can be adjusted to suit the standing operator O and the height of the lab bench.

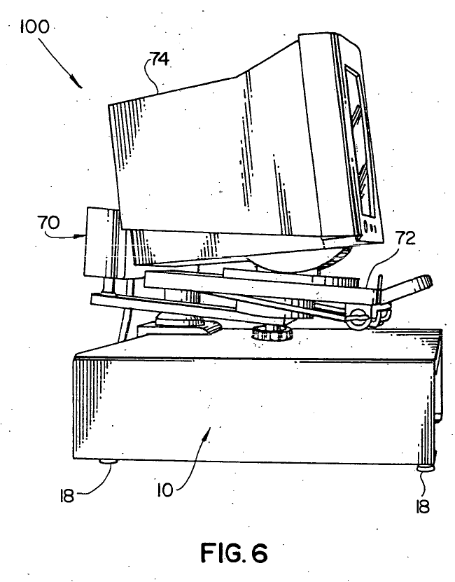

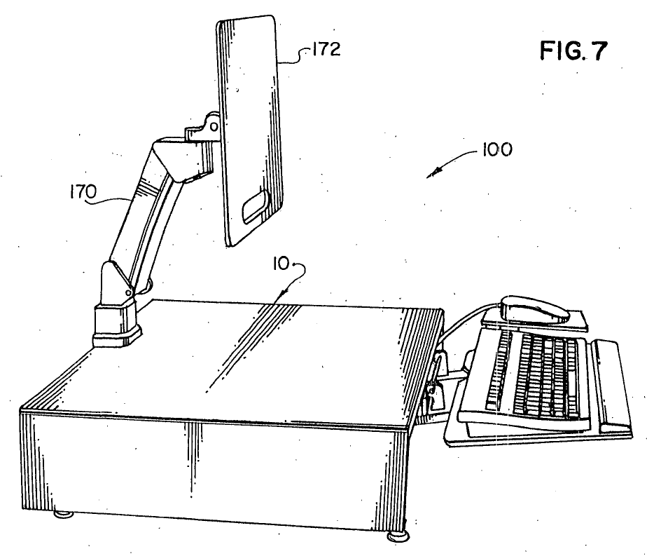

Referring now to FIG. 6, which illustrates computer workstation 100 in the retracted or stored position. A further advantage of computer workstation 100 is that in the retracted position it occupies much less space than prior art portable workstations, such as the sit-stand workstation disclosed in U.S. Pat. No. 6,374,752 to Walser.

It is also envisioned that computer workstation 100 can include features such as a portable copy holder for positioning documents directly in front of the operator and/or a docking station for laptop applications.

While the invention has been described with respect to preferred embodiments, those skilled in the art will readily appreciate that various changes and/or modifications can be made to the invention without departing from the spirit or scope of the invention as defined by the appended claims.

1. A portable workstation for a computer having a keyboard, a mouse and a video monitor comprising:
a) a base unit having an upper surface and at least two legs depending downward therefrom, the two legs being adapted for supporting the workstation on a working surface which is spaced vertically from a floor;
b) a keyboard tray mounted to the base unit, the keyboard tray including a keyboard support surface and means for articulating the keyboard support surface with respect to the upper surface of the base unit; and
c) a monitor arm mounted to the base unit, the monitor arm including a monitor support surface and means for articulating the monitor support surface with respect to the upper surface of the base unit

2. The portable computer workstation as recited in claim 1, further comprising means for securing the base unit to the working surface.

3. The portable computer workstation as recited in claim 1, further comprising means for adjusting the height of the upper surface of the base unit with respect to the working surface.

4. The portable computer workstation as recited in claim 1, wherein the keyboard tray and monitor arm are mounted to the upper surface of the base unit.

5. The portable computer workstation as recited in claim 1, wherein the keyboard support surface is adapted and configured for being articulated vertically and horizontally with respect to the upper surface of the base unit.

6. The portable computer workstation as recited in claim 1, wherein the monitor support surface is adapted and configured for being articulated vertically, horizontally and in a front-to-back direction with respect to the upper surface of the base unit.

7. The portable computer workstation as recited in claim 1, wherein the monitor support surface includes means for securing a video monitor thereto.

8. The portable computer workstation as recited in claim 7, wherein the means for securing a video monitor to the support surface is adapted for supporting a flat panel monitor in an upright position.

9. The portable computer workstation as recited in claim 1, further comprising a mouse tray which is supported by the keyboard tray.

10. The portable computer workstation as recited in claim 1, further comprising adjustable support feet associated with each leg of the base unit.

11. The portable computer workstation as recited in claim 1, wherein the keyboard tray is adapted and configured for articulating between an extended position wherein a keyboard mounted thereon can be accessed by a user and a retracted position wherein the keyboard tray is disposed under the upper surface of the base unit between the legs.

12. A portable workstation for a computer having a keyboard, a mouse and a video monitor comprising:
a) a base unit having an upper surface and at least two legs depending downward therefrom, the two legs being adapted for supporting the workstation on a working surface which is spaced vertically from a floor;
b) a keyboard tray mounted to the base unit, the keyboard tray including a keyboard support surface and means for articulating the keyboard support surface with respect to the upper surface of the base unit;
c) a monitor arm mounted to the base unit, the monitor arm including a monitor support surface and means for articulating the monitor support surface with respect to the upper surface of the base unit; and
wherein the base unit includes means for supporting a laptop docking station.

13. A portable workstation for a computer as recited in claim 12, wherein the base unit is made from aluminum.

14. The portable computer workstation as recited in claim 12, further comprising means for securing the base unit to the working surface.

15. The portable computer workstation as recited in claim 12, further comprising means for adjusting the height of the upper surface of the base unit with respect to the working surface.

16. The portable computer workstation as recited in claim 12, wherein the keyboard tray and monitor arm are mounted to the upper surface of the base unit.

17. The portable computer workstation as recited in claim 12, wherein the keyboard support surface is adapted and configured for being articulated vertically and horizontally with respect to the upper surface of the base unit.

18. The portable computer workstation as recited in claim 12, wherein the monitor support surface is adapted and configured for being articulated vertically, horizontally and in a front-to-back direction with respect to the upper surface of the base unit.

19. The portable computer workstation as recited in claim 1, wherein the monitor support surface includes means for securing a video monitor thereto.

20. The portable computer workstation as recited in claim 1, further comprising adjustable support feet associated with each leg of the base unit.
